(19) United States
(12) Patent Application Publication
(10) Pub. No.: US 2024/0240680 A1
(43) Pub. Date: Jul. 18, 2024

(54) CALIPER BRAKE

(71) Applicant: HL MANDO CORPORATION, Pyeongtaek-si (KR)

(72) Inventor: Jaejin HUR, Seongnam-si (KR)

(73) Assignee: HL MANDO CORPORATION, Pyeongtaek-si (KR)

(21) Appl. No.: 18/378,437

(22) Filed: Oct. 10, 2023

(30) Foreign Application Priority Data
Jan. 12, 2023 (KR) 10-2023-0004877

(51) Int. Cl. F16D 65/00

(52) U.S. Cl. CPC F16D 65/0068; F16D 65/0031

(57) ABSTRACT

A caliper brake according to one embodiment includes a disc rotating together with a wheel and a pair of brake pads disposed on both sides of the disc, includes a caliper housing with the brake pads disposed on an inner side thereof and enclosing at least a part of the disc, a logo body provided to cover at least a part of an outer surface of the caliper housing, and a dust collector configured to collect dust generated by contact between the disc and the brake pads and detachably connected to the logo body, and the dust collector may include a first filter module disposed on one side of the caliper housing and a second filter module disposed on the other side of the caliper housing.

### CROSS-REFERENCE TO RELATED APPLICATION

The present application claims the benefit of priority to Korean Patent Application No. 10-2023-0004877, filed on Jan. 12, 2023 in the Korean Intellectual Property Office, the disclosure of which is incorporated herein by reference.

### BACKGROUND

### 1. Field

Embodiments of the present disclosure relate to a caliper brake, and more particularly, to a caliper brake stably collecting dust generated by friction between a brake pad and a disc and facilitating maintenance of a brake system.

### 2. Description of the Related Art

Recently, as the importance of environmental protection is emphasized, environmental friendliness becomes a big issue in the automobile industry, and regulations on pollutants emitted from automobiles are also being continuously strengthened.

Pollutants emitted from automobiles may be largely classified into pollutants emitted from an exhaust system and pollutants emitted from a non-exhaust system. The pollutants emitted from the exhaust system are pollutants contained in an exhaust gas, which is generated when an engine is driven, and are already subject to regulations. On the other hand, regulations on the pollutants emitted from the non-exhaust system are recently expected to be implemented.

One representative pollutant out of the pollutants emitted from the non-exhaust system may be, e.g., dust generated from a brake system. Specifically, as a brake system mounted in a vehicle, a disc brake obtains a braking force by friction or clamping pressure between a disc and a brake pad by contacting and pressing the brake pad on both sides of the disc rotating together with a wheel. Herein, dust may be generated due to abrasion caused by friction between the disc and the brake pad, and it is known that the dust contains a large amount of substances harmful to the human body.

In addition, recently, a monoblock caliper brake with high rigidity and braking force is being developed and applied to a high-performance vehicle. As the monoblock caliper brake has stronger friction or clamping pressure between a disc and a brake pad, the amount of dust generated therefrom also increases.

Accordingly, a method of responding to a relevant regulation by stably collecting dust or fine dust generated from a brake system and also facilitating the maintenance of the brake system by a user such as a driver or the like is required.

The information included in this Background of the present disclosure is only for enhancement of understanding of the general background of the present disclosure and may not be taken as an acknowledgement or any form of suggestion that this information forms the prior art already known to a person skilled in the art.

### SUMMARY

Various aspects of the present disclosure are directed to a caliper brake capable of stably collecting dust generated by friction between a disc and a brake pad.

Another aspect of the present disclosure is directed to a caliper brake capable of curbing and minimizing external diffusion of dust generated by friction between a disc and a brake pad.

Still another aspect of the present disclosure is directed to a caliper brake whose filter module is detachable to promote easy maintenance of a brake system.

Yet another aspect of the present disclosure is directed to a caliper brake promoting a beautiful appearance despite a filter module mounted thereon.

Yet another aspect of the present disclosure is directed to a caliper brake capable of improving the marketability and competitiveness of a vehicle.

Yet another aspect of the present disclosure is directed to a caliper brake with a simple structure and improved productivity and assemblability of a product.

Additional aspects of the disclosure will be set forth in part in the description which follows and, in part, will be obvious from the description, or may be learned by practice of the disclosure.

In accordance with one exemplary embodiment of the present disclosure, a caliper brake including a disc rotating together with a wheel and a pair of brake pads disposed on both sides of the disc may include: a caliper housing with the brake pads disposed on an inner side thereof and enclosing at least a part of the disc; a logo body disposed to cover at least a part of an outer surface of the caliper housing; and a dust collector configured to collect dust generated by contact between the disc and the brake pads and detachably connected to the logo body, and the dust collector may include a first filter module disposed on a first side of the caliper housing and a second filter module disposed on a second side of the caliper housing.

The first filter module may include a first filter configured to filter out the dust and a first filter cover having a first mounting space in which the first filter is accommodated and supported on an inner circumferential surface of the first filter cover and detachably connected to the logo body.

The first filter module may further include a first fastening member fastening the logo body and the first filter cover to each other or separating the logo body and the first filter cover from each other.

The first filter module may be disposed on a leading portion side of the caliper housing, the first filter may have a first through-hole recessed and formed on an inner circumferential surface of the first filter to enable the disc to pass through, and the first filter module may further include at least one guide wing disposed at one end portion of the first through-hole and guiding an airflow containing the dust toward the first filter.

The guide wing may be angle-adjustable for the first filter.

The guide wing may include a first guide wing facing an outer circumferential surface of the disc and a pair of second guide wings facing one surface and another surface of the disc, respectively.

The first guide wing may be angle-adjustable in a direction parallel to an axial direction of the disc as an axis, and the second guide wings may be angle-adjustable in a direction corresponding to a radial direction of the disc as an axis.

The first filter cover may include at least one first discharge hole through which heat generated by contact between the disc and the brake pads or an airflow with the dust filtered out through the first filter is discharged to an outer side.

A central axis of the at least one first discharge hole may be disposed in a vertical direction.

The second filter module may include a second filter configured to filter out the dust and a second filter cover having a second mounting space in which the second filter is accommodated and supported on an inner circumferential surface of the second filter cover and detachably connected to the logo body.

The second filter module may further include a second fastening member fastening the logo body and the second filter cover to each other or separating the logo body and the second filter cover from each other.

The second filter module may be disposed on a trailing portion side of the caliper housing, and the second filter may have a second through-hole recessed and formed on an inner circumferential surface of the second filter to enable the disc to pass through.

The second filter cover may include at least one second discharge hole through which heat generated by contact between the disc and the brake pads or an airflow with the dust filtered out through the second filter is discharged to an outer side.

A central axis of the at least one second discharge hole may be disposed in a vertical direction.

The logo body may include an exterior portion covering at least a part of a front surface of the caliper housing and to which a logo or an emblem is applicable and a cover portion bent and extending from the exterior portion to cover at least a part of an upper surface of the caliper housing.

The cover portion may include at least one third discharge hole through which heat generated by contact between the disc and the brake pads is discharged to an outer side.

A base bracket supporting the logo body and the dust collector against at least one of a vehicle body, a carrier fixedly installed on the vehicle body, or the caliper housing may be further provided.

The dust collector may further include a first fastening member fastening the logo body and the first filter cover to each other, or separating the logo body and the first filter cover from each other, on a front side of the first filter cover, a second fastening member fastening the logo body and the second filter cover to each other, or separating the logo body and the second filter cover from each other, on a front side of the second filter cover, a third fastening member fastening the logo body and the first filter cover to each other, or separating the logo body and the first filter cover from each other, on a rear side of the first filter cover, and a fourth fastening member fastening the logo body and the second filter cover to each other, or separating the logo body and the second filter cover from each other, on a rear side of the second filter cover.

The first filter and the second filter may be made of metal with corrosion resistance and heat resistance.

In accordance with another aspect of the present disclosure, a caliper brake including a disc rotating together with a wheel and a pair of brake pads disposed on both sides of the disc may include: a caliper housing with the brake pads disposed on an inner side thereof and enclosing at least a part of the disc; a base bracket fastened to and supported by at least one of a vehicle body, a carrier fixedly installed on the vehicle body, or the caliper housing; a dust collector having a first filter module disposed on a first side of the caliper housing and a second filter module disposed on a second side of the caliper housing to collect dust generated by contact between the disc and the brake pads; and a logo body disposed to cover at least a part of an outer surface of the caliper housing, and the dust collector and the logo body may be detachably connected to each other and supported by the base bracket.

A rear side of the first filter module may be detachably connected to the base bracket, a front side of the first filter module may be detachably connected to the logo body, a rear side of the second filter module may be detachably connected to the base bracket, and a front side of the second filter module may be detachably connected to the logo body.

The first filter module may be disposed on a leading portion side of the caliper housing, and the second filter module may be disposed on a trailing portion side of the caliper housing.

In accordance with still another aspect of the present disclosure, a caliper brake including a disc rotating together with a wheel and a pair of brake pads disposed on both sides of the disc may include: a caliper housing with the brake pads disposed on an inner side thereof and enclosing at least a part of the disc; a base bracket fastened to and supported by at least one of a vehicle body, a carrier fixedly installed on the vehicle body, or the caliper housing; and a dust collector having a first filter module disposed on a first side of the caliper housing and a second filter module disposed on a second side of the caliper housing to collect dust generated by contact between the disc and the brake pads, and the dust collector may be detachably connected to the base bracket.

The caliper brake may further include the logo body disposed to cover at least a part of an outer surface of the caliper housing. The first filter module may include a first filter for filtering out the dust and a first filter cover having a first mounting space in which the first filter is accommodated and supported on an inner circumferential surface of the first filter cover and detachably connected to the logo body, and the second filter module may include a second filter for filtering out the dust and a second filter cover having a second mounting space in which the second filter is accommodated and supported on an inner circumferential surface of the second filter cover and detachably connected to the logo body.

The logo body may be integrally formed with the first filter cover and the second filter cover.

The apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a caliper brake according to a first exemplary embodiment of the present disclosure;

FIG. 2 is a front view illustrating the caliper brake according to the exemplary first embodiment of the present disclosure;

FIG. 3 is a plan view illustrating the caliper brake according to the first exemplary embodiment of the present disclosure;

FIG. 4 is a perspective view illustrating the caliper brake according to the first exemplary embodiment of the present disclosure in another direction;

FIG. 5 is an exploded perspective view illustrating the caliper brake according to the first exemplary embodiment of the present disclosure;

FIG. 6 is an exploded perspective view illustrating the caliper brake according to the first exemplary embodiment of the present disclosure in another direction;

FIG. 7 is a perspective view illustrating a state in which a logo body and a dust collector according to the first exemplary embodiment of the present disclosure are supported and mounted on a base bracket;

FIG. 8 is a perspective view in another direction illustrating the state in which the logo body and the dust collector according to the first exemplary embodiment of the present disclosure are supported and mounted on the base bracket;

FIG. 9 is a perspective view illustrating a first filter and a guide wing according to the first exemplary embodiment of the present disclosure;

FIG. 10 is an exploded perspective view illustrating the first filter and the guide wing according to the first exemplary embodiment of the present disclosure;

FIG. 11 is a cross-sectional view taken along line A-A′ in FIG. 3, that is, a cross-sectional view illustrating a first filter cover according to the first exemplary embodiment of the present disclosure;

FIG. 12 is a cross-sectional view taken along line B-B′ in FIG. 3, that is, a cross-sectional view illustrating a second filter cover according to the first exemplary embodiment of the present disclosure;

FIG. 13 is a cross-sectional view of the caliper brake according to the first exemplary embodiment of the present disclosure, illustrating a state in which the dust collector collects dust; and

FIG. 14 is a perspective view of a caliper brake according to a second exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. The following embodiment is provided to fully convey the spirit of the present disclosure to a person having ordinary skill in the art to which the present disclosure belongs. The present disclosure is not limited to the embodiment shown herein but may be embodied in other forms. The drawings may omit the illustration of parts not related to the description in order to clarify the present disclosure, and slightly exaggerate the size of the components to help understanding.

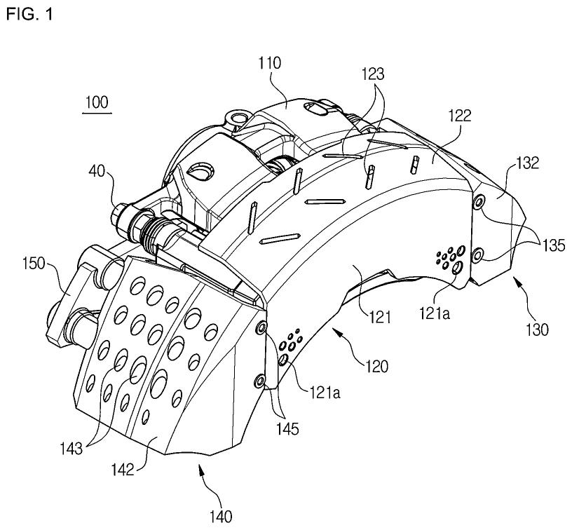

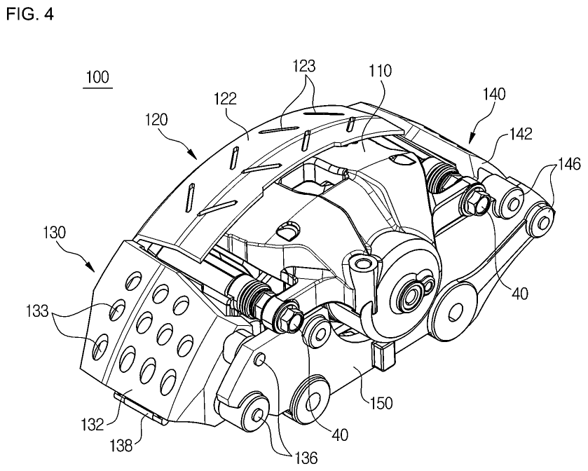

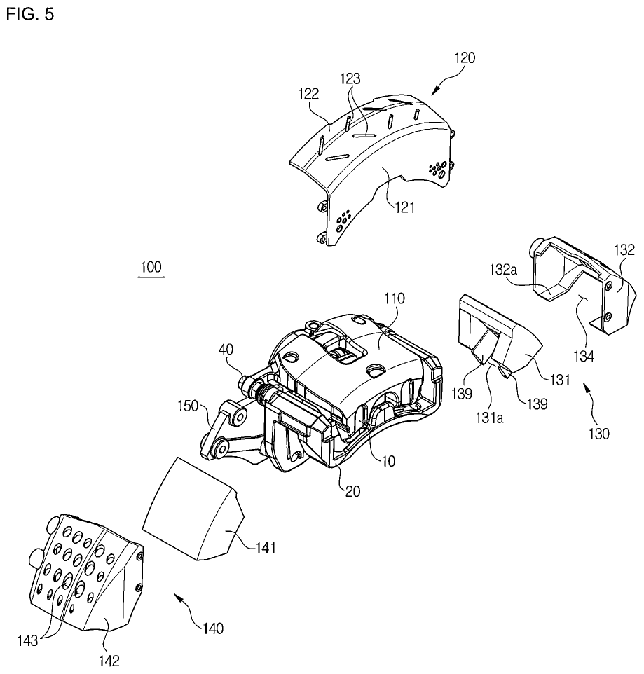

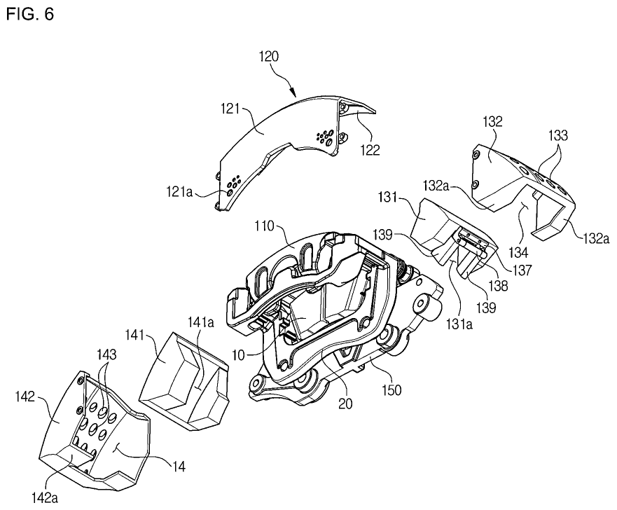

FIGS. 1 to 3 are a perspective view, a front view, and a plan view, respectively, illustrating a caliper brake 100 according to a first exemplary embodiment of the present disclosure, and FIG. 4 is a perspective view illustrating the caliper brake 100 according to the first exemplary embodiment of the present disclosure in another direction. In addition, FIGS. 5 and 6 are exploded perspective views illustrating the caliper brake 100 according to the first exemplary embodiment of the present disclosure in directions different from each other.

Referring to FIGS. 1 to 6, the caliper brake 100 according to the first exemplary embodiment of the present disclosure includes a brake disc (not shown) rotating together with a wheel (not shown) of a vehicle, a pair of brake pads 10 respectively disposed on both inner and outer sides of the disc, a carrier 20 fixedly installed on a vehicle body, a caliper housing 110 with the brake pads 10 disposed on an inner side thereof and provided to slide and move with respect to the carrier 20, a pressing member (not shown) installed to move forward and backward on the caliper housing 110, a guide rod 40 guiding sliding movement of the caliper housing 110 with respect to the carrier 20, a logo body 120 provided to cover at least a part of the caliper housing 110, a dust collector collecting dust generated by contact between the disc and the brake pads 10, and a base bracket 150 supporting the logo body 120 and the dust collector.

The brake disc (not shown) is provided to rotate together with the wheel of the vehicle, and the inner brake pad 10 and the outer brake pad 10 are disposed on both sides of the disc, respectively. The inner brake pad 10 and the outer brake pad 10 are fixedly installed on an inner pad plate and an outer pad plate, respectively, and the brake pads 10 are attached to an inner side surface (surface facing the brake disc) of each of the pad plates, respectively. The inner pad plate is disposed so that an outer side surface thereof is in contact with the pressing member to be described below, and the outer pad plate is installed on an inner side rear surface of the caliper housing 110 to be described below together with the outer brake pad 10. Thus, when the vehicle is braked, the pressing member moves forward and presses the inner pad plate and the inner brake pad 10 toward the brake disc side to bring the inner pad plate and the inner brake pad 10 into close contact with the brake disc side, and by a reaction force thereto, the caliper housing 110 slides in a direction opposite to the forward direction of the pressing member with respect to the carrier 20 fixedly installed on the vehicle body, so that the outer pad plate and the outer brake pad 10 installed in the caliper housing 110 may be pressed toward the brake disc side and brought into close contact with the brake disc side.

The pressing member (not shown) may be configured as a piston and provided to move forward and backward inside a cylinder disposed in the caliper housing 110. The pressing member may perform braking of the vehicle by moving forward by hydraulic pressure of a pressing medium such as brake oil or perform braking of the vehicle by receiving power from an actuator (not shown) to be described below and moving forward. In addition, the pressing member may release the braking of the vehicle by moving backward when the hydraulic pressure of the pressing medium is released, or release the braking of the vehicle or a parking braking state by receiving power from the actuator to be described below and moving backward.

The cylinder is disposed in the caliper housing 110 to enable the piston to move forward and backward and a pair of coupling holes penetrating and formed in both sides of the cylinder in a direction parallel to the forward and backward directions of the pressing member. The guide rod 40 to be described below may be inserted into and fastened to each of the coupling holes, the caliper housing 110 may be connected to and supported by the carrier 20 through the guide rod 40, and the caliper housing 100 may also slide and move with respect to the carrier 20 along the forward and backward directions by the guide rod 40. In the caliper housing 110, a part of a front surface and an upper surface may be covered by the logo body 120 to be described below, and dust collectors to be described below may be provided in a leading portion and a trailing portion of the caliper housing 110. A detailed description thereabout will be presented below.

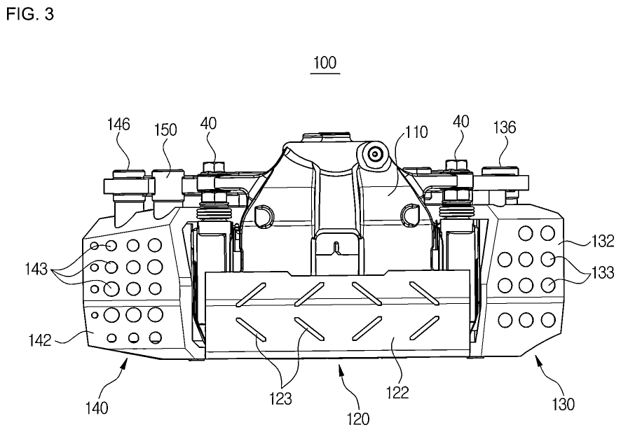

Meanwhile, a front surface (front side) described in the present embodiment means an outer surface (outer side) that a driver or a user can check with the naked eye from the outside of the vehicle and refers to a lower surface (lower side) in FIG. 3. On the other hand, a rear surface (rear side) described in the present embodiment means an opposite side (inner side) of the front surface (front side) and refers to an upper surface (upper side) in FIG. 3.

The carrier 20 may be fixedly installed on a supportable structure such as the vehicle body by a bolt or the like. A guide hole formed by extending along a longitudinal direction of the guide rod 40 may be provided on both sides of the carrier 20 so that the guide rod 40 to be described below may be inserted and pass through the guide hole, and the brake pads 10 and the pad plates may be disposed on an inner side of the carrier 20. A pad spring configured to elastically support the brake pads 10 and the pad plates may be arranged between the carrier 20 and the pad plates. The base bracket 150 to be described below may be disposed on a rear surface side of the carrier 20. Each of the carrier 20 and the base bracket 150 may have a bolt fastening hole to be fixedly installed on the vehicle body by a fastening member such as a bolt or the like, and the bolt fastening hole provided in the carrier 20 and the bolt fastening hole provided in the base bracket 150 may be coaxially disposed so that the carrier 20 and the base bracket 150 may be fixed and supported together by a single fastening member to reduce a component.

The guide rod 40 is disposed to guide the sliding movement of the caliper housing 110 with respect to the carrier 20. The guide rod 40 may be provided in a cylindrical shape extending along the forward and backward directions and disposed on both sides of the pressing member with respect to an axial direction of the pressing member. The guide rod 40 may be fixedly installed by being inserted and fastened to both sides of the caliper housing 110 and disposed to be inserted and pass through the guide hole formed through both sides of the carrier 20 in the forward and backward directions. As the guide rod 40 moves forward or backward along the guide hole when the vehicle is braked or released, the sliding movement of the caliper housing 110 may be guided. At least one sealing member for preventing an inflow of foreign substances may be interposed between an outer circumferential surface of the guide rod 40 and a surrounding area of the guide hole of the carrier 20.

The logo body 120 may be disposed on an outer surface of the caliper housing 110 and thus form an exterior of the caliper brake 100.

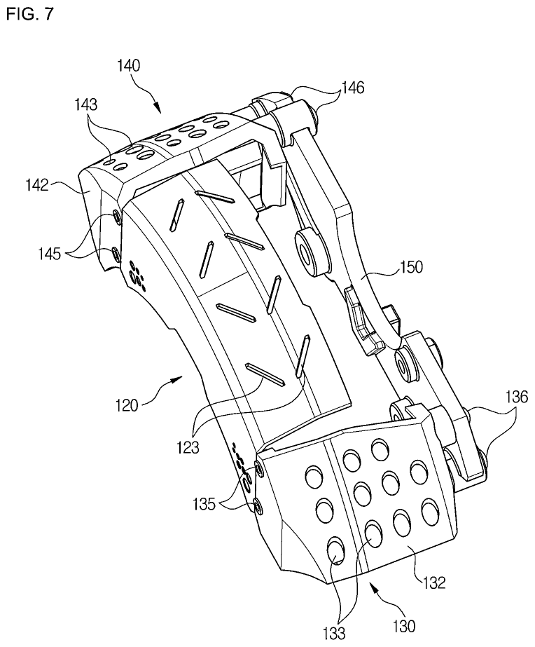

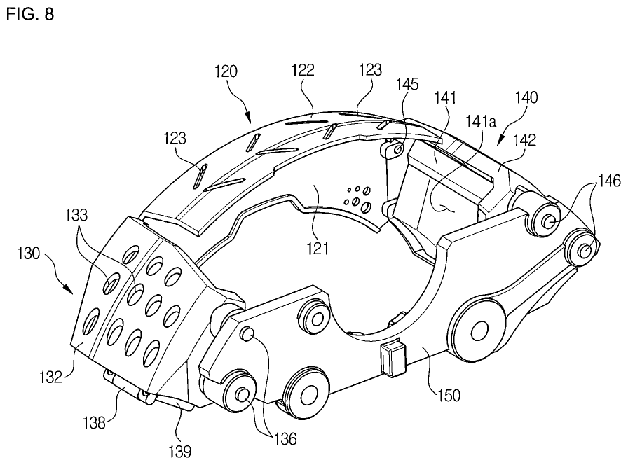

FIGS. 5 and 6 are exploded perspective views illustrating the caliper brake 100 according to the first exemplary embodiment of the present disclosure in directions different from each other. In addition, FIG. 7 and FIG. 8 are perspective views illustrating the state in which the logo body 120 and the dust collector according to the first exemplary embodiment of the present disclosure are supported and mounted on the base bracket 150, in directions different from each other.

Referring to FIGS. 1 to 8, the logo body 120 may be disposed to cover at least a part of the front surface and the upper surface of the caliper housing 110. The logo body 120 may include an exterior portion 121 covering at least a part of the front surface of the caliper housing 110 and to which a logo or an emblem of a product or the vehicle is applicable and a cover portion 122 bent and extending from the exterior portion 121 toward the rear thereof to cover at least a part of the upper surface of the caliper housing 110. The dust collector to be described below is detachably mounted on the logo body 120 so that the dust collector and the logo body 120 may support each other, and the logo body 120 may be stably supported on the vehicle body by being connected and fastened to the base bracket 150 through the first filter cover 132 and the second filter cover 142 to be described below.

The exterior portion 121 may be provided to cover at least a part of the front surface of the caliper housing 110 and thus form an exterior of the product. To this end, at least a part of a front surface of the exterior portion 121 may be provided in a planar shape, and the logo or the emblem may be painted, stamped, or attached thereto. In addition, a fastening bracket connected and fastened to the dust collector to be described below may be disposed on both sides of the exterior portion 121, and a plurality of discharge holes 121a may penetrate and formed at a side part of the exterior portion 121 to smoothly discharge and radiate the heat generated by friction between the disc and the brake pads 10 to the outside thereof.

The cover portion 122 may be formed by being bent and extending from an upper end of the exterior portion 121 to the rear and thus disposed above the caliper housing 110. The cover portion 122 may be formed to correspond to an upper surface shape of the caliper housing 110, and a plurality of discharge holes 123 may penetrate and formed in the cover portion 122 to smoothly discharge and radiate the heat generated by friction between the disc and the brake pads 10 to the outside thereof.

The logo body 120 is provided to enclose not only the caliper housing 110 but also various components disposed therein such as the brake pads 10, the pad plates, and the like and thus may make appearance of the product visible from the wheel or the outside of the vehicle beautiful. In particular, nowadays, the appearance of wheels, which are applied to high-performance vehicles or luxury vehicles, and the caliper brake 100 seen from the outside becomes a very important purchasing decision factor for consumers. Accordingly, the logo body 120 is provided to enclose various components and also to display the product or a brand of the vehicle on the front surface thereof and thus may improve the marketability and competitiveness of the product and the applied vehicle. In addition, as the dust collector to be described below is detachably mounted on both sides of the logo body 120, the stable support of the first and second filter modules 130 and 140 may be promoted.

The dust collector is provided to curb and minimize diffusion of harmful substances by collecting dust generated by contact between the disc and the brake pads 10. In addition, the base bracket 150 is provided to stably support the logo body 120 and the dust collector.

Referring to FIGS. 1 to 8, the base bracket 150 may be disposed at a rear side of the caliper housing 110 and fixedly installed on the vehicle body by a fastening member such as a bolt or the like, and the dust collector may be detachably mounted on the base bracket 150. In addition, the logo body 120 may be detachably connected to and supported by the base bracket 150 through the dust collector. To this end, a plurality of fastening holes, through which a fastening member such as a bolt or the like is inserted and penetrate, may be provided in the base bracket 150, and the base bracket 150 may be provided in a plate shape, formed to enclose only a part of a rear surface of the caliper housing 110 for reducing weight of the product and smoothly discharging the heat, and disposed at a predetermined space from the caliper housing 110 or a surrounding component such as an actuator or the like. In addition, when the base bracket 150 detachably supports the logo body 120 and the dust collector, the base bracket 150 may be fixedly installed on the carrier 20 fixedly installed on the vehicle body or the caliper housing 110.

The dust collector may include a first filter module 130 disposed on one side of the caliper housing 110 and a second filter module 140 disposed on the other side of the caliper housing 110, and may be detachably provided for easy maintenance.

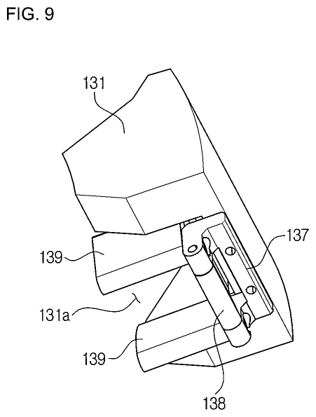

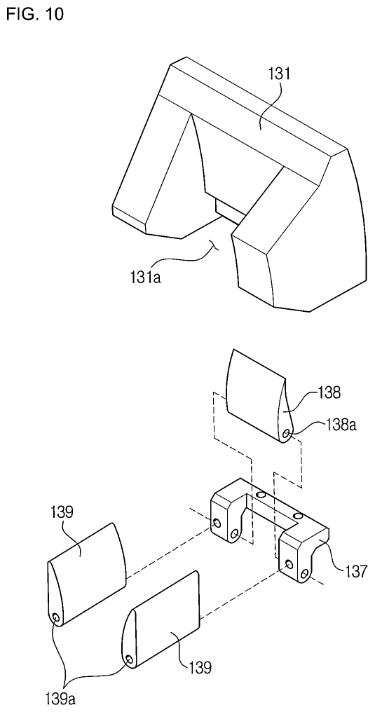

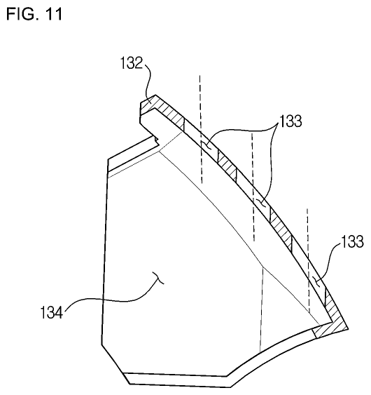

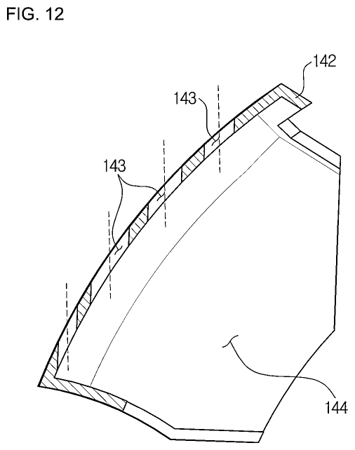

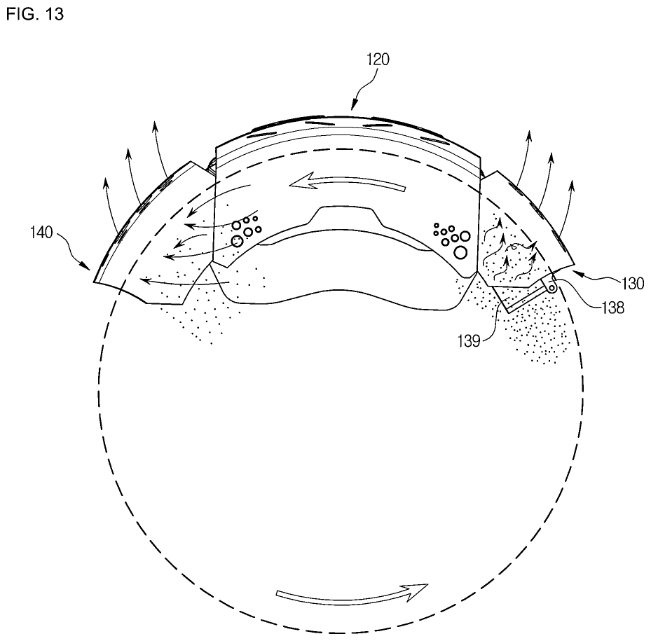

FIG. 9 is a perspective view illustrating the first filter 131 and a guide wing according to the first exemplary embodiment of the present disclosure, and FIG. 10 is an exploded perspective view illustrating the first filter 131 and the guide wing according to the first exemplary embodiment of the present disclosure. In addition, FIG. 11 and FIG. 12 are a cross-sectional view taken along line A-A′ in FIG. 3 and a cross-sectional view taken along line B-B′ in FIG. 3, respectively, that is, cross-sectional views illustrating the first filter cover 132 and the second filter cover 142 according to the first exemplary embodiment of the present disclosure, respectively. FIG. 13 is a cross-sectional view of the caliper brake 100 according to the first exemplary embodiment of the present disclosure, illustrating a state in which the dust collector collects dust.

Referring to FIGS. 1 to 11, the first filter module 130 may be disposed on a leading portion side adjacent to the front of the vehicle with respect to the caliper housing 110. In addition, the first filter module 130 may include the first filter 131 filtering out the dust, the first filter cover 132 having a first mounting space 134, in which the first filter 131 is accommodated and supported, on an inner side thereof, first and third fastening members 135 and 136 detachably supporting the first filter cover 132 (see, e.g., FIG. 7), and a guide wing guiding an airflow containing the dust toward the first filter 131, a front side of the first filter module 130 may be provided to be detachably fastened to the logo body 120, and a rear side of the first filter module 130 may be detachably connected to the base bracket 150.

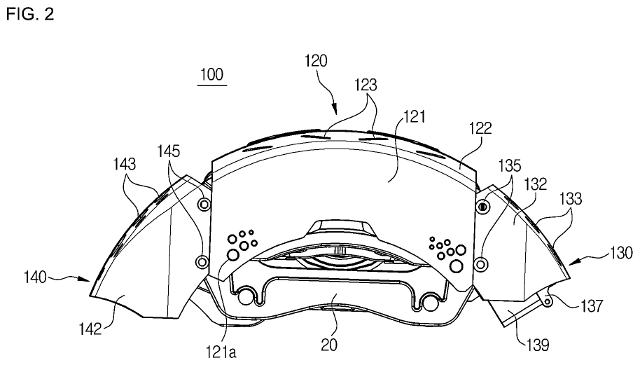

The first filter 131 may receive the airflow containing the dust generated by contact between the disc and the brake pads 10, collect the dust, and discharge the airflow with the dust removed to the outside thereof. The first filter 131 may be seated in and supported by the first mounting space 134 formed on the inner side of the first filter cover 132. In addition, the first filter 131 may be formed in a circular arc shape corresponding to a disc shape, and a first through-hole 131a may be provided to be recessed on an inner circumferential surface thereof to enable the disc to pass through. The first filter 131 may be mounted on and removed from the first mounting space 134 of the first filter cover 132, and thus, when replacement is needed because the first filter 131 is damaged or an endurance period expires, the first filter 131 may be easily removed from the first filter cover 132 and replaced by a new first filter 131. The first filter 131 may be provided using various materials including metals that have corrosion resistance and durability to stably maintain a shape and a function even against high-pressured washing water flowing in an inner side thereof, when the vehicle or the wheel is cleansed, and heat resistance sufficient not to be deformed even by hot-temperature heat. A guide wing guiding the airflow containing the dust toward the first filter 131 may be disposed at one end portion (right end portion in FIG. 2) of the first through-hole 131a of the first filter 131, and a detailed description thereof will be presented below.

The first filter cover 132 may have the first mounting space 134, in which the first filter 131 is accommodated and supported, on an inner side thereof and be detachably connected to at least one of the logo body 120 or the base bracket 150. Like the first filter 131, the first filter cover 132 may be formed in a circular arc shape corresponding to the disc shape, the first mounting space 134 may be defined on an inner circumferential surface of the first filter cover 132, and the first filter 131 may be provided to be mountable in and removable from the first mounting space 134. At a lower end of the first filter cover 132, a first support jaw 132a extending and formed toward an inner side of the first filter cover 132 may be provided to stably support the first filter 131 accommodated in the first mounting space 134 (see, e.g., FIGS. 5 and 6). A predetermined clearance may be provided between the inner circumferential surface of the first filter cover 132 and an outer circumferential surface of the first filter 131, and thus the airflow passing through the first filter 131 may become smooth.

At least one fastening bracket connected and fastened to the logo body 120 may be provided on the other side of a front surface (left end portion in FIG. 2) of the first filter cover 132, and at least one fastening bracket connected and fastened to the base bracket 150 may be provided on a rear surface (upper side surface in FIG. 3). The first filter cover 132 and the logo body 120 may be fastened to or separated from each other by the first fastening member 135, and the first filter cover 132 and the base bracket 150 may be fastened to or separated from each other by the third fastening member 136. The first fastening member 135 and the third fastening member 136 may be provided as bolts, and a fastening hole, into which a bolt is inserted, may be formed through each fastening bracket. As the logo body 120 and the first filter cover 132 are connected to and supported by each other by the first fastening member 135 and the first filter cover 132 and the base bracket 150 are connected to and supported by each other by the third fastening member 136, the logo body 120 and the first filter cover 132 may be stably supported on the vehicle body, and as the first filter cover 132 is detachably mounted with respect to a surrounding component by the first fastening member 135 and the third fastening member 136, the maintenance of the product such as replacement of the first filter 131 or the like may be smoothly performed.

Meanwhile, although not shown in the drawings, the first filter cover 132 and the base bracket 150 may be respectively provided with magnets and thus mounted on and separated from each other by a magnetic force. Likewise, the first filter cover 132 and the logo body 120 may also be respectively provided with magnets and mounted on and separated from each other by a magnetic force, and thus the maintenance of the product such as the replacement of the first filter 131 or the like may become easier.

A plurality of first discharge holes 133 may penetrate and formed in the first filter cover 132 to discharge the heat or the airflow containing the dust generated by contact between the disc and the brake pads 10 to the outside. The first discharge holes 133 may be formed so that the inside and the outside of the first mounting space 134 may communicate with each other, and central axes of the first discharge holes 133 may be disposed in a vertical direction or in a direction corresponding thereto to smoothly radiate the heat generated inside to the outside, such that the central axis of each first discharge hole 133 is angled with respect to the thickness direction of the first filter cover 132.

The guide wing is provided to guide the airflow containing the dust to the first filter 131.

Referring to FIGS. 9 and 10, the guide wing may be provided at one end portion of the first through-hole 131a of the first filter 131, and the guide wing may include a first guide wing 138 provided to face an outer circumferential surface of the disc, a pair of second guide wings 139 provided on both sides of the first guide wing 138 and thus to face the one surface and the other surface of the disc, respectively, and a wing mount 137 connecting and supporting the first and second guide wings 138 and 139 to be angle-adjustable on the first filter 131.

The wing mount 137 may be formed to cover an inner circumferential surface of one end portion of the first through-hole 131a. The wing mount 137 may be provided with a fastening hole for being mounted on the first filter 131, and a first axial hole, into which a rotation axis of the first guide wing 138 is inserted, and a second axial hole, into which a rotation axis of the pair of second guide wings 139 is inserted, may penetrate and formed in the wing mount 137.

The first and second guide wings 138 and 139 may be mounted on the first filter 131 through the wing mount 137. The first and second guide wings 138 and 139 may be formed with cross-sections gradually decreasing along a flow direction of air, and an end portion of a rear side (upper side in FIG. 10) may be formed to incline toward the first filter 131 with respect to the flow direction of air. Thus, as a vortex occurs to the airflow flowing in the first through-hole 131a, a direction of the airflow may be guided toward the first filter 131, and thus dust collection performance of the first filter 131 may be improved.

The first and second guide wings 138 and 139 may be provided to be angle-adjustable for the first filter 131. Specifically, disposition angles of the first and second guide wings 138 and 139 may be adjusted according to an operating environment of the vehicle or a weather environment such as temperature or the like, and thus the collection performance of dust may be maximized. To this end, the first guide wing 138 may be provided to be angle-adjustable on the wing mount 137 in a direction parallel to an axial direction of the disc as an axis 138a, and the pair of guide wings 139 may be provided to be angle-adjustable on the wing mount 137 in a direction orthogonal to the axial direction of the first guide wing 138 and corresponding to a radial direction of the disc as an axis 139a. The first and second guide wings 138 and 139 may be manufactured by being preset at an optimal angle according to an environment of a selling area of the vehicle or the product, and the disposition angles of the first and second guide wings 138 and 139 may also be adjusted variously based on a level required by a user. As the disposition angles of the first and second guide wings 138 and 139 are adjusted as necessary, the dust capture and collection performance of the first filter 131 may be improved despite various operating conditions of the product or the vehicle.

Referring to FIGS. 1 to 8 and FIGS. 12 and 13, the second filter module 140 may be disposed on a trailing portion side adjacent to the rear of the vehicle with respect to the caliper housing 110. In addition, the second filter module 140 may include the second filter 141 filtering out the dust, the second filter cover 142 having a second mounting space 144, in which the second filter 141 is accommodated and supported, on an inner side thereof, and second and fourth fastening members 145 and 146 detachably supporting the second filter cover 142 (see, e.g., FIG. 7), a front side of the second filter module 140 may be provided to be detachably fastened to the logo body 120, and a rear side of the second filter module 140 may be detachably connected to the base bracket 150.

The second filter 141 may receive the airflow containing the dust generated by contact between the disc and the brake pads 10, collect the dust, and discharge the airflow with the dust removed to the outside thereof. The second filter 141 may be seated in and supported by the second mounting space 144 formed on the inner side of the second filter cover 142. In addition, like the first filter 131, the second filter 141 may be formed in a circular arc shape corresponding to a disc shape, and a second through-hole 141a may be provided to be recessed on an inner circumferential surface thereof to enable the disc to pass through. The second filter 141 may be mounted on and removed from the second mounting space 144 of the second filter cover 142, and thus, when replacement is needed because the second filter 141 is damaged or an endurance period expires, the second filter 141 may be easily removed from the second filter cover 142 and replaced by a new second filter 141. The second filter 141 may be provided using various materials including metals that have corrosion resistance and durability to stably maintain a shape and a function even in the high-pressured washing water flowing in an inner side thereof, when the vehicle or the wheel is cleansed, and heat resistance sufficient not to be deformed even at high-temperature.

The second filter cover 142 may have the second mounting space 144, in which the second filter 141 is accommodated and supported, on an inner side thereof and be detachably connected to at least one of the logo body 120 or the base bracket 150. Like the second filter 141, the second filter cover 142 may be formed in a circular arc shape corresponding to the disc shape, the second mounting space 144 may be provided on an inner circumferential surface, and the second filter 141 may be provided to be mountable in and removable from the first mounting space 144. At a lower end of the second filter cover 142, a second support jaw 142a extending and formed toward an inner side of the second filter cover 142 may be provided to stably support the second filter 141 accommodated in the second mounting space 144 (see, e.g., FIG. 6). A predetermined clearance may be provided between the inner circumferential surface of the second filter cover 142 and an outer circumferential surface of the second filter 141, and thus the airflow passing through the second filter 141 may become smooth.

At least one fastening bracket connected and fastened to the logo body 120 may be provided on one side of a front surface (right end portion in FIG. 2) of the second filter cover 142, and at least one fastening bracket connected and fastened to the base bracket 150 may be provided on a rear surface (upper side surface in FIG. 3). The second filter cover 142 and the logo body 120 may be fastened to or separated from each other by the second fastening member 145, and the second filter cover 142 and the base bracket 150 may be fastened to or separated from each other by the fourth fastening member 146. The second fastening member 145 and the fourth fastening member 146 may be provided as bolts, and a fastening hole, into which a bolt is inserted, may be formed through each fastening bracket. As the logo body 120 and the second filter cover 142 are connected to and supported by each other by the second fastening member 145 and the second filter cover 142 and the base bracket 150 are connected to and supported by each other by the fourth fastening member 146, the logo body 120 and the second filter cover 142 may be supported on the vehicle body, and as the second filter cover 142 is detachably mounted with respect to a surrounding component by the second fastening member 145 and the fourth fastening member 146, the maintenance of the product such as replacement of the second filter 141 or the like may be smoothly performed.

Meanwhile, although not shown in the drawings, the second filter cover 142 and the base bracket 150 may be respectively provided with magnets and thus mounted to each other and separated from each other by a magnetic force. Likewise, the second filter cover 142 and the logo body 120 may also be respectively provided with magnets and mounted to each other and separated from each other by a magnetic force, and thus the maintenance of the product such as the replacement of the second filter 141 or the like may become easier.

A plurality of second discharge holes 143 may penetrate and formed in the second filter cover 142 to discharge the heat or the airflow containing the dust generated by contact between the disc and the brake pads 10 to the outside. The second discharge holes 143 may be formed so that the inside and the outside of the second mounting space 144 may communicate with each other, and central axes of the second discharge holes 143 may be disposed in a vertical direction or in a direction corresponding thereto to smoothly radiate the heat generated inside to the outside, such that the central axis of each second discharge hole 143 is angled with respect to the thickness direction of the second filter cover 142.

Like this, the dust collector according to the first exemplary embodiment of the present disclosure may be provided with the first filter module 130 disposed in the leading portion and the second filter module 140 disposed in the trailing portion, and as the first filter module 130 and the second filter module 140 are detachably connected to a surrounding component, a filter module to be maintained may be selectively removed and then remounted, and thus efficiency in operating the product and a user's workability may be improved. Furthermore, operation cost may surely be reduced because a filter to be replaced may be selectively removed and remounted and a component such as a filter cover or the like may be used continuously.

Hereinafter, a caliper brake 200 according to a second exemplary embodiment of the present disclosure will be described.

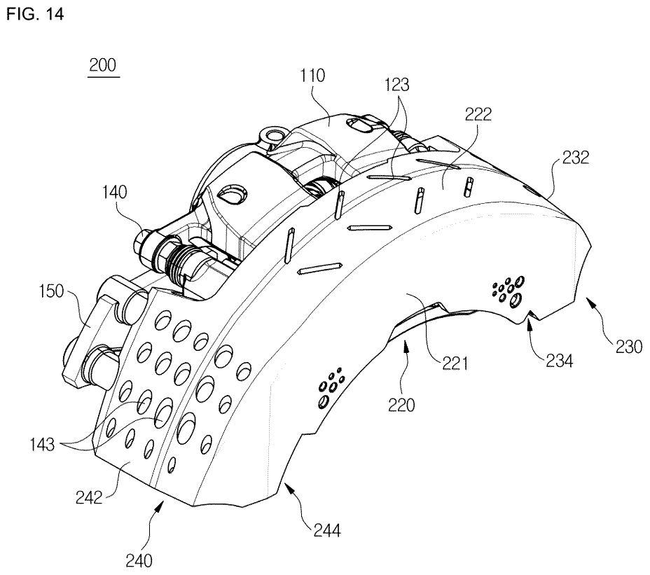

FIG. 14 is a perspective view of the caliper brake 200 according to the second exemplary embodiment of the present disclosure, and referring to FIG. 14, the caliper brake 200 according to the second exemplary embodiment of the present disclosure includes a brake disc (not shown) rotating together with a wheel (not shown) of a vehicle, the pair of brake pads 10 respectively disposed on both sides of the disc, the carrier 20 fixedly installed on a vehicle body, the caliper housing 110 with the brake pads 10 disposed on an inner side thereof and provided to slide and move with respect to the carrier 20, a pressing member installed to move forward and backward on the caliper housing 110, the guide rod 40 guiding sliding movement of the caliper housing 110 with respect to the carrier 20, a logo body 220 provided to cover at least a part of the caliper housing 110, a dust collector collecting dust generated by contact between the disc and the brake pads 10, and the base bracket 150 supporting the logo body 220 and the dust collector.

In the following description of the caliper brake 200 according to the second exemplary embodiment of the present disclosure, the same reference numerals will be used to refer to the same elements in the description of the caliper brake 100 according to the first exemplary embodiment unless otherwise specifically noted, and thus description thereof will be omitted in order to avoid duplication of contents.

The logo body 220 may be provided on an outer surface of the caliper housing 110 and thus form an exterior of the caliper brake 200. The logo body 220 may be disposed to cover at least parts of the front surface and the upper surface of the caliper housing 110 and include an exterior portion 221 covering at least a part of the front surface of the caliper housing 110 and to which a logo or an emblem of a product or the vehicle is applicable and a cover portion 222 bent and extending from the exterior portion 221 toward the rear thereof to cover at least a part of the upper surface of the caliper housing 110. The logo body 220 may be integrally provided with first and second filter covers 232 and 242 of the dust collector and detachably connected to and supported by the base bracket 150.

The dust collector is provided to curb and minimize diffusion of harmful substances by collecting dust generated by contact between the disc and the brake pads 10, and the base bracket 150 is provided to stably support the logo body 220 and the dust collector.

The base bracket 150 may be provided at a rear side of the caliper housing 110 and fixedly installed on the vehicle body by a fastening member such as a bolt or the like, and the dust collector may be detachably mounted on the base bracket 150. In addition, the logo body 220 and the dust collector may be detachably connected to and supported by the base bracket 150.

The dust collector may include a first filter module 230 disposed on one side of the caliper housing 110 and a second filter module 240 disposed on the other side of the caliper housing 110, and may be detachably provided for easy maintenance.

The first filter cover 232 may have a first mounting space 234, in which a first filter (not shown) is accommodated and supported, on an inner side thereof, be integrally provided with the logo body 220, and thus detachably connected to the base bracket 150. To this end, the front surface and the upper surface of the first filter cover 232 may be formed to extend from the logo body 220, and at least one fastening bracket connected and fastened to the base bracket 150 may be provided on the rear surface thereof. The logo body 220, the first filter cover 232, and the base bracket 150 may be fastened to or separated from each other by a fastening member, and thus the logo body 220 and the first filter cover 232 are detachable from a surrounding component so that maintenance of a product such as replacement of the first filter 231 or the like may be smoothly performed. Meanwhile, although not shown in the drawings, the first filter cover 232 and the base bracket 150 may be respectively provided with magnets and mounted on and separated from each other by a magnetic force, and thus maintenance of a product such as replacement of the first filter 231 or the like may become easier.

The second filter cover 242 may have a second mounting space 244, in which a second filter (not shown) is accommodated and supported, on an inner side thereof, be integrally provided with the logo body 220, and thus detachably connected to the base bracket 150. To this end, the front surface and the upper surface of the second filter cover 242 may be formed to extend from the logo body 220, and at least one fastening bracket connected and fastened to the base bracket 150 may be provided on the rear surface thereof. The logo body 220, the second filter cover 242, and the base bracket 150 may be fastened to or separated from each other by a fastening member, and thus the logo body 220 and the first and second filter covers 232 and 242 are detachable from a surrounding component so that maintenance of a product such as replacement of the second filter 231 or the like may be smoothly performed. Meanwhile, although not shown in the drawings, the second filter cover 242 and the base bracket 150 may be respectively provided with magnets and mounted on and separated from each other by a magnetic force, and thus maintenance of a product such as replacement of the second filter 232 or the like may become easier.

As the dust collector according to the second exemplary embodiment of the present disclosure may be provided with the logo body 220, to which a logo or an emblem is applied, and the first and second filter covers 232 and 242 not only integrally with each other but also detachably from a surrounding component, a structure may be simplified and the assemblability of a product may be improved, and as the logo body 220 and the first and second filter covers 232 and 242 may be easily removed from and remounted on the surrounding component again during maintenance such as replacement of a filter, efficiency of operation and a user's workability may be improved. Furthermore, operation cost may surely be reduced because only a filter to be replaced may be selectively removed and remounted and a component such as a filter cover or the like may be used continuously.

A caliper brake according to one exemplary embodiment of the present disclosure can stably collect dust generated by friction between a disc and a brake pad.

A caliper brake according to one exemplary embodiment of the present disclosure can curb and minimize external diffusion of dust generated by friction between a disc and a brake pad.

A caliper brake according to one exemplary embodiment of the present disclosure can have a detachable filter module and thus promote easy maintenance.

A caliper brake according to one exemplary embodiment of the present disclosure can promote a beautiful appearance despite a filter module mounted thereon.

A caliper brake according to one exemplary embodiment of the present disclosure can improve the marketability and competitiveness of a vehicle.

A caliper brake according to one exemplary embodiment of the present disclosure can have a simple structure and improve the productivity and assemblability of a product.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A caliper brake including a disc rotating together with a wheel and a pair of brake pads disposed on both sides of the disc, the caliper brake comprising:
a caliper housing with the brake pads disposed on an inner side thereof and enclosing at least a part of the disc;
a logo body disposed to cover at least a part of an outer surface of the caliper housing; and
a dust collector configured to collect dust generated by contact between the disc and the brake pads and detachably connected to the logo body,
wherein the dust collector includes a first filter module disposed on a first side of the caliper housing and a second filter module disposed on a second side of the caliper housing.

2. The caliper brake of claim 1, wherein the first filter module includes:
a first filter configured to filter out the dust; and
a first filter cover having a first mounting space in which the first filter is accommodated and supported on an inner circumferential surface of the first filter cover and detachably connected to the logo body.

3. The caliper brake of claim 2, wherein the first filter module further includes a first fastening member configured to fasten the logo body and the first filter cover to each other or separate the logo body and the first filter cover from each other.

4. The caliper brake of claim 2, wherein:
the first filter module is disposed on a leading portion side of the caliper housing,
the first filter has a first through-hole recessed and formed on an inner circumferential surface of the first filter to enable the disc to pass through, and
the first filter module further includes at least one guide wing disposed at one end portion of the first through-hole and guiding an airflow containing the dust toward the first filter.

5. The caliper brake of claim 4, wherein the guide wing is configured to be angle-adjustable for the first filter.

6. The caliper brake of claim 4, wherein the guide wing includes:
a first guide wing facing an outer circumferential surface of the disc, and
a pair of second guide wings facing one surface and another surface of the disc, respectively.

7. The caliper brake of claim 6, wherein:
the first guide wing is configured to be angle-adjustable in a direction parallel to an axial direction of the disc as an axis, and
the second guide wings are configured to be angle-adjustable in a direction corresponding to a radial direction of the disc as an axis.

8. The caliper brake of claim 2, wherein:
the first filter cover includes at least one first discharge hole through which heat generated by contact between the disc and the brake pads or an airflow with the dust filtered out through the first filter is discharged to an outer side, and
a central axis of the at least one first discharge hole is disposed in a vertical direction.

9. The caliper brake of claim 2, wherein the second filter module includes:
a second filter configured to filter out the dust; and
a second filter cover having a second mounting space in which the second filter is accommodated and supported on an inner circumferential surface of the second filter cover and detachably connected to the logo body.

10. The caliper brake of claim 9, wherein the second filter module further includes a second fastening member configured to fasten the logo body and the second filter cover to each other or separate the logo body and the second filter cover from each other.

11. The caliper brake of claim 9, wherein:
the second filter module is disposed on a trailing portion side of the caliper housing, and
the second filter has a second through-hole recessed and formed on an inner circumferential surface of the second filter to enable the disc to pass through.

12. The caliper brake of claim 9, wherein:
the second filter cover includes at least one second discharge hole through which heat generated by contact between the disc and the brake pads or an airflow with the dust filtered out through the second filter is discharged to an outer side, and
a central axis of the at least one second discharge hole is disposed in a vertical direction.

13. The caliper brake of claim 9, wherein the logo body includes:
an exterior portion covering at least a part of a front surface of the caliper housing and to which a logo or an emblem is applicable; and
a cover portion bent and extending from the exterior portion to cover at least a part of an upper surface of the caliper housing.

14. The caliper brake of claim 9, wherein the first filter and the second filter are made of metal with corrosion resistance and heat resistance.

15. A caliper brake including a disc rotating together with a wheel and a pair of brake pads disposed on both sides of the disc, the caliper brake comprising:
a caliper housing with the brake pads disposed on an inner side thereof and enclosing at least a part of the disc;
a base bracket fastened to and supported by at least one of a vehicle body, a carrier fixedly installed on the vehicle body, or the caliper housing;
a dust collector having a first filter module disposed on a first side of the caliper housing and a second filter module disposed on a second side of the caliper housing to collect dust generated by contact between the disc and the brake pads; and
a logo body disposed to cover at least a part of an outer surface of the caliper housing,
wherein the dust collector and the logo body are detachably connected to each other and supported by the base bracket.

16. The caliper brake of claim 15, wherein:
a rear side of the first filter module is detachably connected to the base bracket,
a front side of the first filter module is detachably fastened to the logo body,
a rear side of the second filter module is detachably connected to the base bracket, and
a front side of the second filter module is detachably fastened to the logo body.

17. The caliper brake of claim 16, wherein:
the first filter module is disposed on a leading portion side of the caliper housing, and
the second filter module is disposed on a trailing portion side of the caliper housing.

18. A caliper brake including a disc rotating together with a wheel and a pair of brake pads disposed on both sides of the disc, the caliper brake comprising:
a caliper housing with the brake pads disposed on an inner side thereof and enclosing at least a part of the disc;
a base bracket fastened to and supported by at least one of a vehicle body, a carrier fixedly installed on the vehicle body, or the caliper housing; and
a dust collector having a first filter module disposed on a first side of the caliper housing and a second filter module disposed on a second side of the caliper housing to collect dust generated by contact between the disc and the brake pads,
wherein the dust collector is detachably connected to the base bracket.

19. The caliper brake of claim 18, further comprising a logo body disposed to cover at least a part of an outer surface of the caliper housing,
wherein the first filter module includes:
a first filter for filtering out the dust; and
a first filter cover having a first mounting space in which the first filter is accommodated and supported on an inner circumferential surface of the first filter cover and detachably connected to the logo body, and
the second filter module includes:
a second filter for filtering out the dust; and
a second filter cover having a second mounting space in which the second filter is accommodated and supported on an inner circumferential surface of the second filter cover and detachably connected to the logo body.

20. The caliper brake of claim 19,
wherein the logo body is integrally formed with the first filter cover and the second filter cover.
